(19) United States
(12) Patent Application Publication
(10) Pub. No.: US 2004/0023066 A1
(43) Pub. Date: Feb. 5, 2004

(54) Magnetic recording medium and process for producing the same

(76) Inventors: Shigeharu Watase, Hita-shi (JP); Nobuhiro Jingu, Hita-shi (JP); Masao Nakayama, Hita-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/396,814

(22) Filed: Mar. 26, 2003

(30) Foreign Application Priority Data
Mar. 29, 2002 (JP) 2002-093991

(51) Int. Cl. G11B 5/66

(52) U.S. Cl. 428/694 R

(57) ABSTRACT

The present invention provides a magnetic recording medium having a thinned film back coating layer as well as suppressed tribocharging by sliding to the tape guide pin on running, and having excellent running durability, and a method for producing the same. A magnetic recording medium which comprises at least a magnetic layer 3 and a protective layer 4 comprising a hard film containing carbon as a principal component in this order on one surface of a non-magnetic support 2, and comprises a back coating layer 6 comprising a hard film containing carbon as a principal component on the other surface of said non-magnetic support 2, wherein a surface of said back coating layer 6 has a three-dimension center surface roughness SRa in a range of 3 to 7 nm and a three-dimension ten-point average roughness SRz in a range of 30 to 55 nm.

### BACKGROUND OF THE INVENTION

1. Field of the Invention

The present invention relates to a magnetic recording medium of a magnetic metal thin film type, and to a method for producing the same.

2. Disclosure of the Related Art

With progress in information society, magnetic recording media capable of recording data at higher density are keenly demanded, and advances in magnetic recording layers made a shift from the coated type to the so-called magnetic metal thin film type. Since being free from binders as the coated type magnetic recording media in the magnetic layer, the magnetic metal thin film type recording media yield high saturation magnetization and are suitable for high density recording. In the case of magnetic metal thin film type media, used Co—Ni alloys, Co—Cr alloys, Co—O alloys, and the like as the magnetic metals which are directly deposited by means of plating or vacuum thin film forming methods (such as vacuum deposition method, sputtering method, ion-plating method, and the like) on a non-magnetic support such as polyester film, polyamide film, polyimide film, and the like.

The most notable characteristic of long thin film media is that the recording capacity can be easily increased by elongating the winding length. However, due to the explosive increase in the amount of information in recent years, data storage tape with further increased capacity is demanded. In order to increasing the number of tape turns to cope with this requirement, method for enlarging the winding diameter, or for thinning the tape thickness are conceivable. The former results in necessity for re-designing not only the diameter of the reel, but also the cassette casing, and this leads to a considerable increase in production cost. On the other hand, the latter requires thinning the thickness of the film constructing the tape.

To take a tape formed by vacuum deposition which makes advance in thinning tape thickness as an example, a deposited film to be the recording layer has a thickness of about 200 nm, and the carbon-based protective film deposited thereon as a protective layer has a thickness of about 10 nm, a further thinning of these films has little contribution in decreasing the total tape thickness. In contrast to this, the support film has a thickness of about 5 μm, and the back coating layer on the side of running surface has a thickness of about 0.5 μm, and, an increase in the number of turns, i.e., an increase in capacity, can be expected by thinning these layers. However, a decrease in support film thickness leads to a lowered tape stiffness, and this unfavorably influences the recording/reproducing characteristics. Thus, it is believed most preferable to thin the back coating layers for reducing the tape thickness.

Back coating layers are generally formed by coating a support film surface with a coating material prepared from a material containing carbon black, inorganic pigments (such as calcium carbonate) and the like, and a solvent. However, by taking the coating technique into consideration in view of productivity, it becomes difficult to control the thickness of the back coating layer with high precision as the back coating layer thickness thins down.

In place of forming the back coating layer by coating, Japanese Patent Laid-Open No. 54935/1997 discloses a magnetic recording medium comprising double layered back coating layer comprising a 80 nm thick diamond-like carbon (DLC) thin film and on the support and a 90 nm thick graphite thin film on the diamond-like carbon thin film. Since a diamond-like carbon thin film has poor electric conductivity, and decreases tribocharging by sliding to the tape guide pin on running, a graphite thin film is provided thereon as a solid lubricant. However, in the case graphite thin film is provided on the sliding surface, friction in molecular level occurs to cause unfavorable dropouts due to the generation of particulates.

In Japanese Patent No. 2,638,113 disclosed is a magnetic recording media having a back coating layer comprising diamond-like carbon thin film formed on a fine-particle coated layer on a support. In order to reduce tribocharging due to sliding by the diamond-like carbon thin film, a fine-particle coated layer is provided as an undercoat layer. However, it requires providing a back coating layer comprising diamond-like carbon thin film on the undercoat layer with a thickness of about 0.4 μm on the support, and this cannot contribute to thin the tapes.

### SUMMARY OF THE INVENTION

As described above, the technique is yet to be realized for replacing the coating type back-coating layer, which is difficult to control the thin film thickness with high precision, with a back coating layer comprising diamond-like carbon thin film, although it is believed effective in thinning the total thickness of the tapes.

Furthermore, by thinning the back coating layer as diamond-like carbon thin film, the support film thickness can be increased at the expense of thinning the back coating layer in the case the total tape thickness is made the same as above. The lowest of the strength per unit thickness in data storage tapes at present is the back coating layer of a coated type, and by increasing the thickness of the support film brought by thinning the back coating layer, the strength of the tape as a whole can be increased to improve durability.

In light of such circumstances, it is demanded to thin the back coating layer by the diamond-like carbon thin film, and further to suppress tribocharging due to the diamond-like carbon thin film.

Accordingly, an object of the present invention is to provide a magnetic recording medium having a thinned film back coating layer as well as suppressed tribocharging by sliding to the tape guide pin on running, and having excellent running durability. Further, another object of the present invention is to provide a method for producing above magnetic recording medium.

The present inventors have extensively and intensively conducted studies, and as a result, they have found that the above objects can be achieved by producing the magnetic recording medium by using a non-magnetic support having, on the side for providing the back coating layer comprising a hard film containing carbon as a principal component, a surface with a three-dimension center surface roughness SRa in a range of 3 to 7 nm and a three-dimension ten-point average roughness SRz in a range of 30 to 55 nm. The present invention has been accomplished based on these findings.

The present invention provides a magnetic recording medium which comprises at least a magnetic layer and a protective layer comprising a hard film containing carbon as a principal component in this order on one surface of a non-magnetic support, and comprises a back coating layer comprising a hard film containing carbon as a principal component on the other surface of the non-magnetic support, wherein a surface of the back coating layer has a three-dimension center surface roughness SRa in a range of 3 to 7 nm and a three-dimension ten-point average roughness SRz in a range of 30 to 55 nm.

The present invention provides above magnetic recording medium, which further comprises a lubricant layer on the protective layer.

The present invention provides above magnetic recording medium, wherein the magnetic layer is a metal thin film type magnetic layer.

The present invention provides above magnetic recording medium, wherein the other surface of the non-magnetic support has a three-dimension center surface roughness SRa in a range of 3 to 7 nm and a three-dimension ten-point average roughness SRz in a range of 30 to 55 nm.

The present invention provides above magnetic recording medium, wherein the non-magnetic support is a laminate support having two or more layers.

The present invention provides above magnetic recording medium, wherein the back coating layer has a thickness of from 3 to 300 nm.

The present invention provides a method for producing a magnetic recording medium comprising the steps of:

forming a magnetic layer on one surface of a non-magnetic support by means of vapor phase film formation method,

forming a protective layer comprising a hard film containing carbon as a principal component on the magnetic layer by means of vapor phase film forming method, and

forming a back coating layer comprising a hard film containing carbon as a principal component on the other surface of the non-magnetic support set to have a three-dimension center surface roughness SRa in a range of 3 to 7 nm and a three-dimension ten-point average roughness SRz in a range of 30 to 55 nm, by means of vapor phase film forming method. With this producing method, the magnetic recording medium having a three-dimension center surface roughness SRa in a range of 3 to 7 nm and a three-dimension ten-point average roughness SRz in a range of 30 to 55 nm is obtained.

In the present invention, “containing carbon as a principal component” signifies that content of atomic carbon in the film is from 60 to 80%, and in general, hydrogen is contained in the film in addition to carbon. The atomic ratio of hydrogen to carbon (H/C) is preferably in a range of from 0.25 to 0.66. “To be hard film” means, specifically, that to be a film having a Vicker's hardness of 6370 N/mm² (650 kg/mm²) or higher, and this hardness, as expressed by refractive index, corresponds to a value of 1.9 or higher. A film having such a refractive index is known that the hardness can be approximated from the refractive index. For instance, when a refractive index is 1.9the Vicker's hardness is 6370 N/mm² (650 kg/mm²). There is especially no upper limit in refractive index, but is about 2.25, and it corresponds to Vicker's hardness of 29400 N/mm² (3000 kg/mm²). As a method for obtaining approximate value of hardness from refractive index, there may be mentioned measuring the refractive index of the hard film with an ellipsometer, while measuring Vicker's hardness with micro hardness meter (manufactured by NEC Corporation), and preparing a calibration curve in advance to find the value of hardness from the refractive index. Furthermore, such hard films are amorphous, or form a continuous phase that is nearly amorphous, and yield broad peaks at 1,560 cm⁻¹ and 1,330 cm⁻¹ when measured by Raman spectroscopy. The term hard carbon film or DLC film is employed hereinafter in the sense of “hard films containing carbon as a principal component”.

According to the present invention, there is provided a magnetic recording medium having a thinned film back coating layer as well as suppressed tribocharging by sliding to the tape guide pin on running, and having excellent running durability.

### BRIEF DESCRIPTION OF THE DRAWINGS

FIG. 1 is a cross section view showing an example of layer constitution of a magnetic recording medium according to the invention.

FIG. 2 is a cross section view showing an example of layer constitution of a magnetic recording medium according to the invention.

FIG. 3 is a schematic drawing of an apparatus for measuring slide friction coefficient.

### DETAILED DESCRIPTION OF THE INVENTION

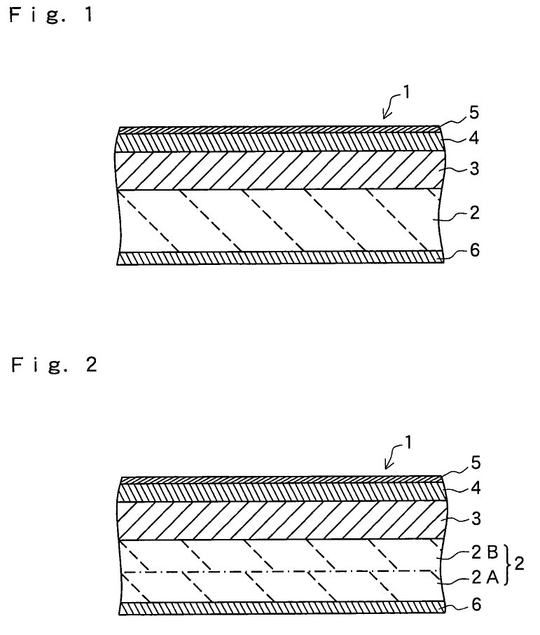

The magnetic recording medium according to the invention is described below by making reference to FIGS. 1 and 2.

FIGS. 1 and 2 are each cross section views showing an example of layer constitution of a magnetic recording medium according to the invention. Referring to FIGS. 1 and 2, a magnetic recording medium (1) comprises, on the surface of one side of a non-magnetic support (2), a magnetic layer (3), a protective layer (4) comprising a hard carbon film, and a lubricant layer (5) in this order; and comprises, on the surface of the other side of the non-magnetic support (2), a back coating layer (6) comprising a hard carbon film.

There is no particular limitation concerning the material for the non-magnetic support (2), and is selected from resins such as polyester-based resins such as polyethylene terephthalate (PET) and polyethylene naphthalate (PEN), polyamide-based resins such as aromatic polyamides, and olefin-based resins such as polyethylene and polypropylene. The thickness of the non-magnetic support is selected from a range from 3 to 12 μm, depending on aimed time for imaging-recording or recording, or the like. In order to make the entire tape thinner, in particular, the thickness of the non-magnetic support is preferably selected from a range of 3 to 6 μm.

In the non-magnetic support (2) for use in the present invention, the surface of the side for providing a back coating layer (6) has a three-dimension center surface roughness SRa in a range of 3 to 7 nm and a three-dimension ten-point average roughness SRz in a range of 30 to 55 nm. By forming a hard carbon film on the non-magnetic support (2) having a surface with such a surface roughness by means of vapor phase film forming method, there can be obtained a magnetic recording medium according to the present invention having a back coating layer (6) surface with a three-dimension center surface roughness SRa in a range of 3 to 7 nm and a three-dimension ten-point average roughness SRz in a range of 30 to 55 nm.

On the other hand, the surface of the side of the non-magnetic support (2) for forming thereon a magnetic layer (3) is an ordinary smooth surface with no particular limitation; however, preferably, for instance, it has a three-dimension center surface roughness SRa in a range of 0.5 to 2 nm and a three-dimension ten-point average roughness SRz in a range of 5 to 20 nm. In the case the surface roughness of the side of the non-magnetic support (2) for forming thereon the magnetic layer (3) becomes rougher than the range above, the surface of the magnetic layer (3) results in a rough surface, which makes favorable electromagnetic conversion properties unfeasible.

Such a non-magnetic support (2) having surfaces differing in roughness may be obtained by providing the support (2) by laminating two ((2A) and (2B)) or more layers. FIG. 2 shows a magnetic recording medium (1) comprising a support (2) having a laminate support comprising two layers (2A) and (2B). In the laminate support (2), the surface of the layer (2A) on which the back coating layer (6) is provided has a three-dimension center surface roughness SRa in a range of 3 to 7 nm, preferably from 3.5 to 6.7 nm, and more preferably, from 5.0 to 6.7 nm; and a three-dimension ten-point average roughness SRz in a range of 30 to 55 nm, preferably from 32 to 52 nm, and more preferably, from 39 to 52 nm. On the other hand, the surface of the layer (2B) on which the magnetic layer (3) is provided preferably has a three-dimension center plane roughness SRa in a range of 1 to 2 nm and a three-dimension ten-point average roughness SRz in a range of 5 to 20 nm.

Used as such a non-magnetic support (2) is, for example, a laminated biaxially oriented polyester film as described below.

The laminated biaxially oriented polyester film according to the present invention is constructed from two layers of polyester layer 2A and polyester layer 2B. The polyesters of the two layers may be of the same type or of the different types, but preferred are of the same type.

In the laminated biaxially oriented polyester film according to the present invention, the polyester 2A comprises at least two lubricant particles differing in average particle diameter, and preferably, all of the average particle diameter of the lubricant particles is 0.1 μm or larger but smaller than 0.4 μm.

In the polyester layer 2A, it is preferred that two or more lubricant particles containing at least lubricant particle I and lubricant particle II differing from each other in average particle diameter are used. The average particle diameter of lubricant particle I is 0.2 μm or larger but smaller than 0.4 μm, preferably 0.25 μm or larger but smaller than 0.35 μm, and particularly preferably, about 0.3 μm. In the case the average particle diameter of lubricant particle I falls smaller than 0.2 μm, the surface roughness of polyester layer 2A tends to be smooth, and not to maintain sufficient running properties in a drive. On the other hand, in the case the average particle diameter of lubricant particle I is 0.4 μm or larger, the surface roughness of polyester layer 2A tends to be too rough, and to cause difficulties in achieving favorably both running properties and electromagnetic conversion properties at the same time. The content of lubricant particle I in the polyester layer 2A is in a range of 0.1 to 0.5 wt %, and preferably, 0.15 to 0.4 wt %. In the case the content falls lower than 0.1 wt %, sufficient running properties in a drive tend not to be maintained. On the other hand, in the case the content exceeds 0.4 wt %, it is difficult to achieve satisfactory electromagnetic conversion properties. Furthermore, the average particle diameter of lubricant particle II is preferably smaller than that of lubricant particle I. The content of lubricant particle II in the polyester layer 2A is in a range of 0.1 to 0.5 wt %, preferably, 0.15 to 0.4 wt %, and more preferably, 0.2 to 0.3 wt %. In the case the content falls lower than 0.1 wt %, sufficient running properties when in drive tends not to be maintained. On the other hand, in the case the content exceeds 0.5 wt %, the surface roughness becomes rough, to be hard to achive satisfactory electromagnetic conversion properties.

In the polyester layer 2B, on the other hand, it is preferred that lubricant particle having an average particle diameter of 0.05 to 0.1 μm is used in an amount of 0.005 to 0.1 wt %, preferably 0.005 to 0.05 wt %, in polyester layer 2B. In the case the average particle diameter exceeds 0.1 μm, or in the case the content exceeds 0.1 wt %, the surface of the magnetic layer (3) to be formed on polyester layer 2B becomes rough.

The type of lubricant particle used in the polyester layers 2A and 2B is not particularly limited, and usable are, silica particles, crosslinked polystyrene resin particles, crosslinked silicone resin particles, and crosslinked acrylic resin particles and the like.

The laminated biaxially oriented polyester film according to the present invention may be produced by a known method. For instance, it may be obtained by first forming a non-oriented laminated film, and by then biaxially orienting the film. The non-oriented film may be prepared by means of a known method for producing laminated films, such as co-extrusion. The thus obtained non-oriented laminate film may be subjected to a method for producing a biaxially oriented polyester film to obtain the biaxially oriented film. For instance, a non-stretched laminate film is produced by melting and co-extruding the resin in the temperature range of from melting point Tm° C. to (Tm+60)° C.; then, the thus obtained non-stretched laminate film is stretched in the longitudinal direction for 2.0 to 6.0 times, preferably 2.5 to 5.5 times, and particularly preferably, for 3.0 to 5.0 times, at a temperature in the range of from (Tg−10)° C. to (Tg+70)° C. (provided Tg represents the glass transition temperature of polyester) and is then stretched in the transverse direction for 3.0 to 7.5 times, preferably 3.5 to 7.0 times, and particularly preferably, for 4.5 to 6.5 times at a temperature in the range of from Tg° C. to (Tg+70)° C. Furthermore, if necessary, the stretched product may be stretched again in the longitudinal and the transverse directions. Moreover, the biaxially oriented film may be thermally fixed at a temperature in the range of from (Tg+70)° C. to (Tm−10)° C., for instance, in the temperature range of from 190 to 250° C., more preferably, from 200 to 240° C. The duration of thermal fixing is preferably from 1 to 60 seconds.

A laminated biaxially oriented polyester film favorable as a non-magnetic support (2) may be obtained in this manner. The film thickness of the polyester layer 2A and the polyester layer 2B is not particularly limited; for instance, the polyester layer 2A may be set to 0.5 to 2 μm thick and the polyester layer 2B may be set to 2.5 to 5.5 μm thick, and a non-magnetic support may be set to 3 to 6 μm in thickness.

The magnetic layer (3) is formed on the surface of one side of the non-magnetic support (2) (i.e., on layer (2B) shown in FIG. 2) by means of vapor film forming methods such as vacuum deposition and ion plating. As the magnetic materials, used are Co or an alloy containing Co, such as Co—Ni, Co—Cr, Co—O, Fe—Co—Ni, Co—Pt, Co—Fe, and the like. In the case of vapor film forming such as vacuum deposition, those having similar boiling points are in the form of alloy, and those having different boiling points are subjected to multi-element vacuum deposition. In the case of sputtering and the like, on the other hand, metal or alloys are subjected to film forming as they are. A tape-like medium is subjected to oblique vapor film forming.

For the vacuum deposition of the magnetic layer, the magnetic material is molten by an electron gun after evacuating the inside of the vacuum deposition chamber to about 10⁻⁵ Torr, and the non-magnetic support is run along a cooled main roller (cooling can) at the point the entire magnetic material is molten, such that the vapor deposition may be initiated at the main roller part. In order to control the magnetic characteristics, an oxidizing gas selected from oxygen, ozone, and nitrous oxide may be introduced to the magnetic layer. In a long extended medium, oblique film forming is performed, such that the column is set to make an angle of 20 to 50 degrees with respect to the non-magnetic support. In the case of a vertical medium, on the other hand, the crucible is set just below the can to set the aperture portion of the mask at an angle within ±10 degrees.

The magnetic layer is a mono-layered or a multi-layered constitution. The thickness of the magnetic layer is in a range of about 0.01 to 0.5 μm.

A hard carbon film (DLC film) as a protective layer (4) is formed on the magnetic layer (3) by means of CVD or sputtering method. Both sputtering and CVD methods are processes using charged particles. Sputtering method is a physical process; firstly an inert gas such as gaseous Ar and the like is ionized (plasma generation) by using an electric field or a magnetic field, further the thus ionized argon ion is accelerated to knock out the target atoms by the kinetic energy, and the knocked out atoms are deposited on the substrate disposed opposed to the target to form the desired film. The film forming rate of DLC film using sputtering method is generally low, and it is a means of film forming inferior in productivity from industrial viewpoint. On the other hand, CVD method causes chemical reactions such as decomposition, synthesis, and the like of gas to be raw material using the energy of the plasma generated by ionization or magnetic field to thereby form a film. In the invention, there is no problem in using sputtering method, but preferred is CVD method capable of forming films at high speed.

As the gas for use in CVD method, those which are in the gaseous state under ordinary temperature and pressure, such as methane, ethane, propane, butane, ethylene, propylene, and acetylene, are easy for handling, or there is also no problem in using liquid starting materials.

The gas above is introduced in a reaction system, high frequency is applied to generate plasma state, and vapor phase film forming is carried out. More specifically, in a chamber (vacuum cell) provided with supply roller, take-up roller, main roller equipped with cylindrical face electrode plates (with arc-shaped cross section) for plasma polymerization opposed to each other at a distance, and path roller if necessary, the starting material roll (wound non-magnetic support with a vapor deposited ferromagnetic metal into roll) is set on the supply roller, and then evacuate the chamber to a pressure as low as 10⁻⁹ Torr or lower, followed by performing plasma polymerization with introducing gaseous hydrocarbon at a predetermined amount such that the reaction pressure in a range of 1 to 10⁻² Torr would be achieved. The amount of the gas introduced is set optionally as required, because it depends on the size of the chamber.

There is no particular restriction concerning high frequency, however, stable discharge easy for handling is obtained in the range of from around 1 kHz to 1 MHz. At frequencies lower than 1 kHz, it is difficult to form film for a long time, and at frequencies higher than 1 MHz, it is not easy to obtain hard films. The range easy to operate is preferably in the range from about 50 kHz to 450 kHz. The film thickness of the hard carbon film is in a range of from 2 to 20 nm, and preferably in a range of around from 5 to 10 nm. A film thinner than 2 nm cannot exhibit its function as a protective film, on the other hand, films thicker than 20 nm suffer problems of spacing loss.

Since the lubricants are coated on the DLC film with difficulty, post-treatment may be performed after forming the DLC film. The post-treatment is preferably carried out by using gaseous oxygen or a gas containing oxygen, and usable gases are, for instance, oxygen, air, and gaseous carbon dioxide. The post treatment is easily performed by a procedure similar to that for forming DLC film. The frequency range for use in post-treatment is preferably in the range of from 1 kHz to 40 MHz like in forming DLC films, and particularly, effects are easily displayed in the range of from 50 kHz to 13.56 MHz.

A lubricant layer (5) is formed on the hard carbon protective layer (4) by coating. As the lubricant, L lubricant containing fluorine, a hydrocarbon based ester, or a mixture of these may be used.

The lubricant is, for instance, those having a basic structure expressed by R¹—A—R², where,

R¹: CF₃(CF₂)ₙ—, CF₃(CF₂)ₙ(CH₂)ₘ—, CH₃(CH₂)₁—, or H;

A: —COO—, —O—, or —COOCH(C₁H₂₁₊₁)CH₂COO—: and

R²: CF₃(CF₂)ₙ—, CF₃(CF₂)ₙ(CH₂)ₘ—, CH₃(CH₂)₁—, or H; provided that

preferably R¹ differs from R², and n satisfies a numeral in a range of from 7to 17, m from 1 to 3, and 1 from 7to 30. Furthermore, higher lubricating effect is displayed in the case R¹ and/or R² are straight-chain group. In the case n is smaller than 7, water-repelling properties become low, and in the case n is larger than 17, friction cannot be lowered because blocking phenomenon occurs between the lubricant and the non-magnetic support or the back coating layer. Particularly preferred among them is a lubricant containing fluorine. Furthermore, two or more of these lubricants may be mixed.

A coating solution is prepared by dissolving these lubricants in a solvent such as ketones, hydrocarbons, and alcohols. As the ketones, there may be mentioned acetone, methyl ethyl ketone (MEK), methyl isobutyl ketone, cyclohexanone, diethyl ketone, and the like. As hydrocarbons, examples include normal- and iso- hydrocarbons such as hexane, heptane, octane, nonane, decane, undecane, and dodecane. Alcohols include methanol, ethanol, propanol, and isopropanol. Thus prepared coating solution is applied on the hard carbon protective layer (4) and dried to provide the lubricant layer (5). The thickness of the lubricant layer (5) is not to be measured accurately, but it is believed to be about several nanometers. The amount of lubricant may be controlled by the concentration of the coating solution. Forming of the lubricant layer (5) by coating may be performed after forming the back coating layer (6) comprising hard carbon film, which is later stated.

A hard carbon film (DLC film) as a back coating layer (6) is formed on the other surface of the non-magnetic support (2) (i.e., on layer (2A) shown in FIG. 2) in a manner similar to the case of hard carbon protective layer (4).

The back coating layer (6) has at a thickness of about 3 to 300 nm, preferably, about 5 to 50 nm, and more preferably, about 5 to 10 nm. The DLC film is a carbon film higher in hardness, and it sufficiently functions as back coating with such a thickness. In the case the film thickness is less than 3 nm, the strength of the DLC film becomes insufficient to cause instability on the resistance against scratches.

The surface roughness of the back coating layer (6) reflects of the surface roughness of the layer (2A) of the non-magnetic support (2), resulting in a three-dimension center surface roughness SRa in a range of 3 to 7 nm, preferably from 3.5 to 6.7 nm, and more preferably, from 5.0 to 6.7 nm; and a three-dimension ten-point average roughness SRz in a range of 30 to 55 nm, preferably from 32 to 52 nm, and more preferably, from 39 to 52 nm. An ordinary DLC film suffers low electric conductivity. However, magnetic recording medium in the present invention, three-dimension center surface roughness SRa and three-dimension ten-point average roughness SRz of the back coating layer (6) comprising DLC film are set in a specified range, namely, to provide a properly roughened surface. Thus, in the magnetic recording medium of the present invention, although the back coating layer (6) is constructed from DLC film, the tribocharging that generates to the guide pin is considerably suppressed to exhibit excellent running durability, as well as electromagnetic conversion properties. In the case that, concerning the back coating layer (6), an SRa value is smaller than 3 nm or an SRz value is smaller than 30 nm, the tribocharging that generates on sliding on running is not suppressed, and seizure by guide pin occurs or flaws generate on the back coating surface. On the other hand, in the case SRa value exceeds 7 nm or SRz value exceeds 55 nm, the surface roughness is transferred to the surface of the magnetic layer to impair the electromagnetic conversion properties.

### EXAMPLES

The invention is described further concretely by way of examples below, but it should be understood that the invention is not limited thereto.

### Example 1

A magnetic recording medium having the layer constitution shown in FIG. 2 was prepared by the following process.

(Preparation of Non-Magnetic Support)

Dimethyl-2,6-naphthalate and ethylene glycol was polymerized by an ordinary method under the presence of manganese acetate as the ester exchange catalyst, antimony trioxide as the polymerization catalyst, and phosphorous acid as the stabilizer, while adding 0.3 wt % (with respect to the total weight of dimethyl-2,6-naphthalate and ethylene glycol, which is the same hereinafter) of spherical silica 0.3 μm in average particle diameter and 0.2 wt % of spherical silica 0.1 μm in average particle diameter as the lubricant particles. Thus, for use as layer A, there was obtained polyethylene-2,6-naphthalate (PEN) having an intrinsic viscosity of 0.61 dl/g as pellet A.

Separately, polyethylene-2,6-naphthalate(PEN) for use as layer B was prepared as pellet B in the same manner as above, except for changing the lubricant particle to 0.02 wt % of spherical silica 0.1 μm in average particle diameter.

The pellet A and pellet B of polyethylene-2,6-naphthalate thus obtained were each dried at 170° C. for 6 hours, and then pellet A and pellet B were supplied to the hopper of two extruders at a weight ratio of the pellet A and pellet B of A/B=1/4. Then, the pellets were molten at a melting temperature of 290° C., and by using a co-extrusion die, layer A was laminated on one side of layer B, the product was then extruded on a rotating cooling drum to obtain a 95 μm thick laminated non-stretched film. The laminated non-stretched film was stretched 3.9 times on the longitudinal direction, cooled rapidly, and was supplied sequentially to a stenter to stretch 5.5 times in the transverse direction. The resulting biaxially stretched film was subjected to thermal fixing under hot air of 210° C. for 4 seconds to obtain a laminated biaxially oriented polyester film 4.4 μm in thickness. The Young's modulus of the resulting PEN film was 550 kg/mm² in longitudinal direction and 1100 kg/mm² in transverse direction. Thus was prepared a PEN film support (2).

(Preparation of Magnetic Recording Medium)

A ferromagnetic Co thin film was formed on the layer B (2B) side of the PEN film (2) by means of oblique vacuum forming to obtain a 0.1 μm thick magnetic layer (3). Then, on the magnetic layer (3), a protective layer (DLC film) having a 10 nm thick hard carbon film was formed by means of plasma CVD method. Post treatment (plasma treatment) was performed on the DLC film by using gaseous O₂.

Subsequently, a back coating layer (DLC film) (6) having a 10 nm thick hard carbon film (DLC film) was formed by means of plasma CVD method on the layer A (2A) side of the PEN film (2).

Furthermore, on the protective layer (4), a lubricant coating solution is coated by dye nozzle method, and was dried to form a 5 nm thick lubricant layer (5). The resulting product was then cut to 8-mm width to obtain a magnetic tape sample having a total thickness of about 4.5 μm.

The lubricant coating solution was a solution obtained by dissolving a fluorine-containing compound of succinic acid derivative and a fluorine-containing compound of aliphatic ester shown below at the same mass amounts in a 1/2/7 mixed solvent of MEK/hexane/ethanol so as to have 0.5 wt % of total concentration of the lubricant.

(Lubricant)

HOOCCH(C₁₄H₂₉)CH₂COOCH₂CH₂(CF₂)₇CF₃

CH₃(C₁₆H₃₂)COOCH₂CH₂(CF₂)₇CF₃

### Example 2

A support was prepared in the same manner as in Example 1, except for changing the lubricant particles added in the preparation of PEN for layer A to 0.4 wt % of spherical silica 0.3 μm in average particle diameter and 0.2 wt % of spherical silica 0.1 μm in average particle diameter, to obtain a sample of magnetic tape.

### Example 3

A support was prepared in the same manner as in Example 1, except for changing the lubricant particles added in the preparation of PEN for layer A to 0.35 wt % of spherical silica 0.3 μm in average particle diameter and 0.5 wt % of spherical silica 0.1 μm in average particle diameter, to obtain a sample of magnetic tape.

### Example 4

A support was prepared in the same manner as in Example 1, except for changing the lubricant particles in the preparation of PEN for layer A to 0.15 wt % of spherical silica 0.3 μm in average particle diameter and 0.2 wt % of spherical silica 0.1 μm in average particle diameter, to obtain a sample of magnetic tape.

### Example 5

A sample of magnetic tape was prepared in the same manner as in Example 1, except for changing the thickness of the back coating layer (6) to 100 nm.

### Comparative Example 1

A support was prepared in the same manner as in Example 1, except for changing the lubricant particles in the preparation of PEN for layer A to 0.2 wt % of spherical silica 0.5 μm in average particle diameter and 0.2 wt % of spherical silica 0. 1 μm in average particle diameter, to obtain a sample of magnetic tape.

### Comparative Example 2

A support was prepared in the same manner as in Example 1, except for changing the lubricant particles in the preparation of PEN for layer A to 0.2 wt % of spherical silica 0.3 μm in average particle diameter and 0.55 wt % of spherical silica 0.2 μm in average particle diameter, to obtain a sample of magnetic tape.

### Comparative Example 3

A support was prepared in the same manner as in Example 1, except for changing the lubricant particle in the preparation of PEN for layer A to 0.05 wt % of spherical silica 0.1 μm in average particle diameter, to obtain a sample of magnetic tape.

### Comparative Example 4

A sample of magnetic tape was prepared in the same manner as in Example 1, except for preparing the PEN film (2) in such a manner that the thickness was 3.9 μm, and for forming a back coating layer on one side of the layer A (2A) of the PEN film (2) by applying an ordinary coating solution of the composition below for the back coating layer using die nozzle method so that the dry thickness was 0.5 μm, and drying to form the back coating layer.

(Composition of coating solution for the back coating layer)

| | |
|---|---|
| Carbon black (80 nm in particle diameter) | 10 parts by weight |
| Carbon black (20 nm in particle diameter) | 40 parts by weight |
| Calcium carbonate (70 nm in particle diameter) | 50 parts by weight |
| Nc (nitrocellulose) (BTH1/2S; manufactured by | 40 parts by weight |
| Asahi Chemical Industry Co., Ltd.) | |
| Polyurethane resin (UR-8300; manufactured | 60 parts by weight |
| by Toyobo Co., Ltd.) | |
| Methyl ethyl ketone | 800 parts by weight |
| Toluene | 640 parts by weight |
| Cyclohexanone | 160 parts by weight |
| Polyisocyanate (solid content 50%) | 40 parts by weight |
| (Coronate L; manufactured by Nippon | |
| Polyurethane Industries Co., Ltd.) | |

[Three-Dimension Center Plane Roughness SRa and Three-Dimension Ten-Point Average SRz]

SRa and SRz data of the surface of the back coating layer (6) of the thus obtained magnetic tape sample were acquired using Surfscoder E-30HT (manufactured by Kosaka Kenkyusho Co., Ltd.) under the conditions below by taking average for n=10.

Measuring conditions:

Magnification: 50,000 times

Measuring length: 0.5 mm

Cut off: 25 μm

Measured points: 30 points

Just the same, three-dimension center plane roughness SRa and three-dimension ten-point average roughness SRz were obtained on layer A (2A) of PEN film (2).

Furthermore, just the same, three-dimension center plane roughness SRa and three-dimension ten-point average roughness SRz were obtained on the surface of magnetic layer (3) before forming thereon the hard carbon protective layer (4).

[Running Durability]

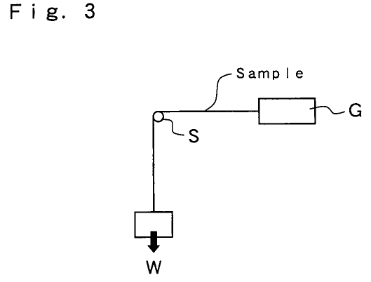

The coefficient of dynamic friction of the side of the running surface (i.e., the side of back coating layer surface) of the thus obtained magnetic tape samples was measured by using a sliding friction coefficient measuring apparatus as shown schematically in FIG. 3. Referring to FIG. 3, one end of the magnetic tape sample was attached to a strain gauge G, and load W was applied in such a manner that the sample may be brought into contact with the slide pin S. In order to evaluate the running durability of the magnetic tape, the magnetic tape sample was repeatedly slid against the slide pin S for 2,000 paths, and measurements were made on the initial coefficient of friction for the first path and the final coefficient of friction for the 2000th path. Further, as an indication of change in the coefficient of friction, the increase ratio of friction coefficient was calculated in accordance with equation 1. The generation of flaws on the sliding surface was observed after the measurement.

$$I ncrease ratio of friction coefficient ( \% ) = [ ( final coefficient of friction - initial coefficient of friction ) / initial coefficient of friction ] \times 100 \qquad ( Equation 1 )$$

Material of slide pin: SUS303 φ2

Surface property of slide pin: 0.2 S

Winding angle: 90°

Sliding speed: 35 mm/s

Load: 20 gf

The evaluation of surface flaws was expressed based on the following standards.

◯: No flaws observed.

Δ: Few flaws are observed, but are of no practical problem.

×: Considerable amount of flaws are observed.

[Electromagnetic Conversion Properties]

By using Mammoth-2 (manufactured by Exabyte Corporation) as the drive, the following measurements were performed under room temperature environment (at 20° C., 60%).

The drive above and the objective tape samples were each set in the above environment of measuring for 6 hours to be accustomed to the environment. While recording a sinusoidal wave at 2 T (21 MHz) in the drive by using Write head, reproduction was performed by using Read head. The reproduction output (RF) from the Read head was taken out from TP (test point) of the above drive, and the output for input frequency (21 MHz) was measured using a spectrum analyzer (Model 4395A manufactured by Agilent Technologies, Inc.). The measured value was displayed in relative values with respect to the measured value for the tape sample of Example 1 taken at 0 dB.

[Short Scale Durability]

By using Mammoth-2 (manufactured by Exabyte Corporation) as the drive and Vista (Visual SCSI Test Application) software provided by Exabyte Corporation, the following operation was conducted under room temperature environment (at 20° C., 60%).

The drive above and the objective tape samples were each set in the above environment of measuring for 6 hours to be accustomed to the environment. Random data of 288 Mbyte were undergone Write/Read process while the tape was run on the drive. The running pattern was set as such that the (Writing 288 Mbytes of data→Rewinding→Reading 288 Mbytes of data→Rewinding) sequence would be repeated. The runs were counted by incrementing the count per pattern above up to 1000 counts.

TABLE 1

| | A-layer | | Back coating | | | | Friction coefficient | | | Flaws | Electromagnetic | |
|---|---|---|---|---|---|---|---|---|---|---|---|---|
| | of support | | layer | | Magnetic layer | | | | Increase | by sliding | conversion | Short |
| | SRa | SRz | SRa | SRz | SRa | SRz | | 2000 | ratio | After | properties | scale |
| | (nm) | (nm) | (nm) | (nm) | (nm) | (nm) | 1 path | paths | (%) | 2000 paths | (dB) | durability |
| Example 1 | 5 | 39 | 5 | 39 | 1.3 | 15 | 0.26 | 0.41 | 58 | Δ | 0 | fine |
| Example 2 | 5.5 | 52 | 5.5 | 52 | 1.3 | 16 | 0.25 | 0.38 | 52 | Δ | −0.1 | fine |
| Example 3 | 6.7 | 45 | 6.7 | 45 | 1.4 | 18 | 0.26 | 0.38 | 46 | Δ | −0.1 | fine |
| Example 4 | 3.5 | 32 | 3.5 | 32 | 1.2 | 14 | 0.27 | 0.42 | 56 | Δ | 0.1 | fine |
| Example 5 | 5 | 39 | 5 | 39 | 1.3 | 15 | 0.25 | 0.38 | 52 | ◯ | 0.1 | fine |
| Comparative | 5 | 61 | 6.5 | 61 | 1.4 | 15 | 0.26 | 0.48 | 85 | X | −0.3 | running |
| Example 1 | | | | | | | | | | | | stop |
| Comparative | 8.1 | 47 | 8.1 | 47 | 2.2 | 21 | 0.23 | 0.34 | 48 | Δ | −1 | fine |
| Example 2 | | | | | | | | | | | | |
| Comparative | 1.7 | 13 | 1.7 | 13 | 1.2 | 14 | 0.29 | 0.52 | 79 | X | 0.2 | running |
| Example 3 | | | | | | | | | | | | stop |
| Comparative | 5 | 39 | 5 | 39 | 1.3 | 16 | 0.23 | 0.34 | 48 | ◯ | −1.7 | edge |
| Example 4 | | | | | | | | | | | | damage |

The results are given in Table 1. In the tape samples of Examples 1 to 5, in Table 1, the increase in sliding friction coefficient was suppressed, and that the flaw generation on the sliding surface was in a practically negligible level. The electromagnetic conversion properties and short scale durability were also favorable.

On the other hand, in Comparative Example 1, the surface of the back coating layer was too rough, as a result, increase of sliding friction coefficient was large and thereby many flaws were generated on the sliding surface. Furthermore, running stop occurred during evaluation of short scale durability. In Comparative Example 2, since the surface of the back coating layer was too rough, as a result, the transfer to the surface of the magnetic layer side was occurred, and this impaired the electromagnetic conversion properties. In Comparative Example 3, the surface of the back coating layer was too smooth, and this led to an increase in friction, which resulted in an increase in sliding friction coefficient and in a generation of many flaws on the sliding. surface. Furthermore, runing stop occurred during evaluation of short scale durability. In Comparative Example 4, electromagnetic conversion properties were impaired due to low stiffness. Furthermore, edge damages occurred during evaluation of short scale durability.

On measuring the refractive index of the film formed on an Si wafer under the same conditions for forming the back coating layer (DLC film) in each examples and comparative examples by using an ellipsometer (manufactured by Mizojiri Kogaku Kogyo K.K.),those values were found to be 2.1. Furthermore, the atomic ratio of hydrogen to carbon (H/C) measured by means of ERDA (Elastic Recoil Detection Analysis) was found to be 0.3. Further, the back coating layers of each examples and comparative examples it was found that they have broad peaks at 1,560 cm⁻¹ and 1,330 cm⁻¹ in Raman spectroscopy.

What is claimed is:

1. A magnetic recording medium which comprises at least a magnetic layer and a protective layer comprising a hard film containing carbon as a principal component in this order on one surface of a non-magnetic support, and comprises a back coating layer comprising a hard film containing carbon as a principal component on the other surface of said non-magnetic support, wherein a surface of said back coating layer has a three-dimension center surface roughness SRa in a range of 3 to 7 nm and a three-dimension ten-point average roughness SRz in a range of 30 to 55 nm.

2. The magnetic recording medium according to claim 1, which further comprises a lubricant layer on said protective layer.

3. The magnetic recording medium according to claim 1, wherein said magnetic layer is a metal thin film type magnetic layer.

4. The magnetic recording medium of claim 1, wherein the other surface of said non-magnetic support has a three-dimension center surface roughness SRa in a range of 3 to 7 nm and a three-dimension ten-point average roughness SRz in a range of 30 to 55 nm.

5. The magnetic recording medium of claim 1, wherein said non-magnetic support is a laminate support having two or more layers.

6. The magnetic recording medium of claim 1, wherein said back coating layer has a thickness of 3 to 300 nm.

7. A method for producing a magnetic recording medium comprising the steps of:
forming a magnetic layer on one surface of a non-magnetic support by means of vapor phase film formation method,
forming a protective layer comprising a hard film containing carbon as a principal component on said magnetic layer by means of vapor phase film forming method, and
forming a back coating layer comprising a hard film containing carbon as a principal component on the other surface of said non-magnetic support set to have a three-dimension center surface roughness SRa in a range of 3 to 7 nm and a three-dimension ten-point average roughness SRz in a range of 30 to 55 nm, by means of vapor phase film forming method.
